(19) United States
(12) Patent Application Publication
(10) Pub. No.: US 2007/0144302 A1
(43) Pub. Date: Jun. 28, 2007

(54) Core and rod cable connection apparatus and method

(76) Inventor: Dennis Graham, Reading, PA (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/314,158

(22) Filed: Dec. 22, 2005

(51) Int. Cl. F16C 1/26; F16C 1/20

(52) U.S. Cl. 74/502.5

(57) ABSTRACT

In accordance with one embodiment of the present invention, a push pull cable apparatus includes a push pull cable connection, that has a rod having a first diameter and a core disposed adjacent the rod wherein the core has a second diameter and wherein the first diameter and the second diameter are substantially similar. In accordance with another embodiment of the present invention, a method of manufacturing a push pull cable connection, includes providing a rod, forming a first counter bore into the rod, forming a second counter bore into the rod, inserting a second layer into the first counter bore, surrounding the second layer with a core jacket, and removing a portion of the core jacket along a length of the core jacket.

### FIELD OF THE INVENTION

The present invention relates generally to cables. More particularly, the present invention relates to push pull cable.

### BACKGROUND OF THE INVENTION

Push-pull cables are commonly included in automatic transmission shifters, mechanical latches, hydraulic valve control operations and many other devices. A typical push-pull cable, such as an automatic transmission shift cable, allows for back and forth movements of one or more components inside of a casing. Push-pull cables transmit compressive forces and tensile forces from an actuator at one end to a receiving part at the other end of the push-pull cable.

Typical operation between push-pull cables and actuators may be problematic for several reasons. Components of the push-pull cables may not be well supported and may buckle in use. Also, the amount of compressive force that can be transmitted between the actuator and the cable may be limited. Contaminant may enter the cable hindering the operation of the cable.

FIG. 4 is a cross sectional view of a core 84 according to the prior art. Core 84 includes a center wire 86 surrounded by strand wires 88 encased in a tubular core jacket 90. The core jacket 90 has splines 92 circumferentially spaced about the perimeter. Gaps 94 exist between the splines 92. A conduit 96, tubular in shape, houses the core 84.

The splines 92 and the gaps 94 according to the prior art are small. Some cable systems may desire small splines to maximize the amount of force that can be transmitted by a cable residing in a conduit 96 at a given diameter.

FIG. 5 is a detailed view of a junction 97 of a core 84 with a rod 98, according to the prior art. In particular, a core 84 is inserted into one end of a rod 98 according to the prior art. A first counter bore 100 is formed for a length A in the rod 98. A second counter bore 102 is formed for a length B in the rod 98. The second counter bore 102 has a diameter substantially similar to the diameter of the core 84. Thus, the entire circumference of the core 84 is enclosed by the rod 98 because the core's 84 diameter is smaller than that of the hole in the rod 98.

The active member of a push-pull cable is a rigid member such as a rod and a flexible member such as the core. The rigid member and cable connection is important because it provides a means for transmitting force between the rigid member and the flexible core. In addition, the connection should seal contaminant from entering the push-pull cable. Contaminant can not only hinder the operation of the push-pull cable, but it can corrode the cable as well.

Accordingly, it is desirable to provide a push-pull cable and connection apparatus to connect the cable with an actuator, along with a method of manufacturing the same, that extends the usefulness of the push-pull cable and connector. Moreover, it is desirable to provide a push-pull cable connector apparatus that is capable of increasing the amount of compressive force that can be transmitted. In addition, it is desirable to provide a push-pull cable that is well supported and functions effectively. It is also desirable to provide a push-pull cable and connection apparatus that reduces or eliminates the amount of contaminant entering the cable. Thus, it is desirable to provide a push-pull cable and connection apparatus that performs the at lest some of the above mentioned features, while still being easy to manufacture and assemble.

### SUMMARY OF THE INVENTION

The foregoing needs are met, to a great extent, by the present invention, wherein in one aspect an apparatus is provided that in some embodiments provides a push-pull cable whose components are well supported, can increase the amount of compressive force that is transmitted and reduces or eliminates the amount of contaminant that enters the cable, while still being easy to manufacture.

In accordance with one embodiment of the present invention, a push pull cable connection, includes a rod having a first diameter, and a core disposed adjacent the rod, wherein the core has a second diameter and wherein the first diameter and the second diameter are substantially similar.

In accordance with yet another embodiment of the present invention, the core includes a center coaxial with the rod, a plurality of wires wrapped around the center, and a core jacket encasing the plurality of wires, wherein the core jacket has a plurality of splines circumferentially spaced on the core jacket and wherein the core jacket has a second diameter substantially similar to the first diameter.

In accordance with yet another embodiment of the present invention, the rod has a first counter bore and a second counter bore disposed within the rod, the center is disposed adjacent the rod, the plurality of wires are wrapped around the center, and a core jacket encasing the plurality of wires, wherein the core jacket includes a plurality of splines and wherein a core jacket diameter is substantially similar to a rod diameter.

In accordance with another embodiment of the present invention, a method of manufacturing a push pull cable connection, includes providing a rod, forming a first counter bore into the rod, forming a second counter bore into the rod, wherein the second bore has a first diameter, inserting a center into the first counter bore, surrounding the center with a core jacket, and removing a circumferential portion of the core jacket along a length of the core jacket wherein a remaining circumferential portion of the core jacket has a second diameter substantially similar to the first diameter.

In accordance with yet another embodiment of the present invention, a push pull cable system, includes a first supporting means, and a second supporting means disposed adjacent the first supporting means, wherein the first supporting means comprises a first diameter and the second supporting means comprises a second diameter, and wherein the first diameter and the second diameter are substantially similar.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a side view illustrating a push-pull cable connection of a rod and core according to an embodiment of the present invention.

FIG. 2 is a cross sectional view along the 2-2 line of FIG. 1.

FIG. 3 is a detailed view of a rod/core junction according to an embodiment of the present invention.

FIG. 4 is a cross sectional view of a core according to the prior art.

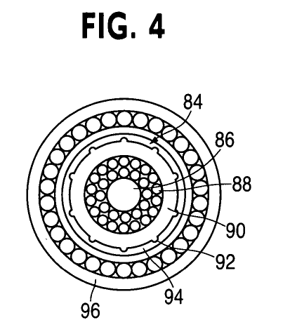

FIG. 5 is a detailed view of a rod/core junction according to the prior art.

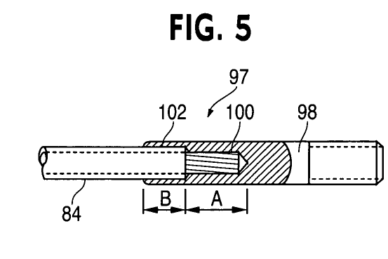

### DETAILED DESCRIPTION

The invention will now be described with reference to the drawing figures, in which like reference numerals refer to like parts throughout. An embodiment in accordance with the present invention provides a push-pull cable connection between a rod and a core within the push-pull cable. In some embodiments of the present invention, components of the push-pull cable are well supported, which can provide an increased amount of compressive force that is transmitted compared to unsupported designs and reduces or eliminates the amount of contaminant that enters the cable, while still being easy to manufacture.

A push-pull cable and associated connection apparatus as disclosed have broad application but will be discussed further with respect to a push-pull cable and connection apparatus being used in a marine vehicle. An operator of a marine vehicle having a push-pull cable as per an embodiment of the present invention, can steer the vehicle by an operator actuating means such as, for example, but not limited to, a steering wheel connected to a push-pull cable. A core within the push-pull cable is movable axially by a steering wheel on the marine vehicle. Other means of moving the core may also be used. A rod coupled to the core imparts axial actuating forces to the core. The rod and core are slidably mounted within the push-pull cable.

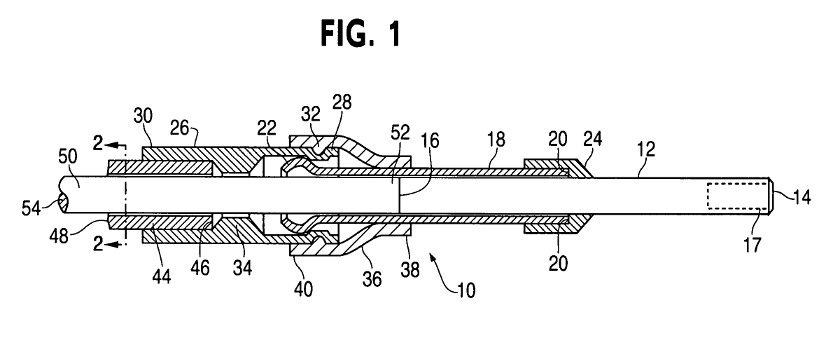

FIG. 1 is a side view illustrating a push-pull cable connection 10 of a rod 12 and core 50 according to an embodiment of the present invention. At the push-pull cable connection 10, there is a rod 12 having a first end 14 and a second end 16. At the first end 14, there are threads 17 that enable the rod 12 to couple to an operator actuating means, such as a steering wheel or throttle control (not shown). The rod 12 may be fabricated from carbon steel, stainless steel or other suitable materials. In some embodiments of the invention , the rod 12 is cylindrical in shape. A portion of the rod 12 is housed within a swivel sleeve 18.

The threads 17 of the first end 14 of the rod 12 connect the rod 12 to a power source (not shown). This power source may communicate axial movement to the rod 12. The power source may be any input of force to the push-pull cable connection 10 from knobs, cables, hydraulic or pneumatic cylinders or the like.

The rod 12 enters the push-pull cable connection 10 via a rod seal 24 and is then encased by the swivel sleeve 18. The rod seal 24 protects the push-pull cable connection 10 from contaminants such as water, from entering the push-pull cable connection 10. The rod seal 24 junction keeps the rod 12 and the swivel sleeve 18 from becoming disengaged as the rod is actuated. The swivel sleeve 18 has a first end 20 and a second end 22. The swivel sleeve 18 is disposed at its second end 22 in a hub 26. The second end 22 of the swivel sleeve 18 is flared outwardly and then returns to the swivel sleeve's 18 original diameter to engage the hub 26.

The hub 26 has a first end 28 and a second end 30. The hub 26 is tubular in shape, having an opening extending axially along the length of the hub 26. Disposed on the hub 26 is a sleeve groove 32 and a core groove 34. The core groove 34 provides support for the core 50 and prevents the core 50 from excessive movement. The sleeve groove 32 engages the second end 22 of the swivel sleeve 18. The sleeve groove 32 maintains the swivel sleeve 18 within the connection 10. The swivel sleeve 18 extends coaxially from the hub 26.

A sleeve seal 36 encases the junction of the swivel sleeve 18 with the hub 26. In particular, a first end 38 of the sleeve seal 36 is attached to the swivel sleeve 18, while a second end 40 of the sleeve seal 36 is attached to the hub 26. In this manner, the sleeve seal 36 keeps the swivel sleeve 18 and the hub 26 in alignment and also prevents contaminant from entering the junction of the swivel sleeve 18 and the hub 26.

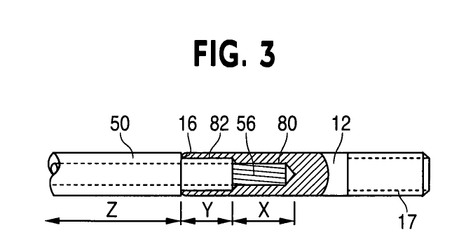

Towards the second end 30 of the hub 26, a conduit 44 is disposed within the hub 26. The conduit 44 has a first end 46 and a second end 48. The hub 26 couples to the conduit 44 with a threaded connection. In other embodiments of the invention, the hub 26 and conduit 44 may connect using a press fit connection or any suitable means. The first end 46 of the conduit 44 lies adjacent the core groove 34. Housed within the conduit 44 is the core 50 having a first end 52 and a second end 54. The core 50 may couple to the rod 12 with a press fit connection or any other suitable connection. Specifically, the first end 52 of the core 50 is attached to the second end 16 of the rod 12. The connection between the core 50 and the rod 12 is illustrated and explained in more detail with respect to FIG. 3.

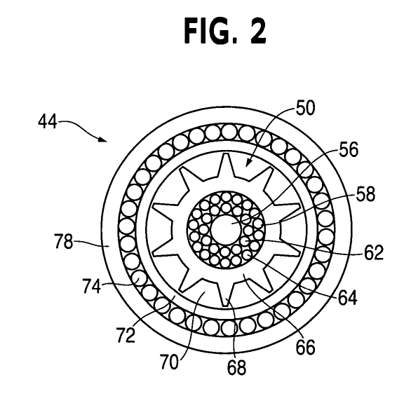

FIG. 2 is a cross sectional view along the 2-2 line of FIG. 1. The core 50 is shown in greater detail. The core 50 has a cylindrical center 56. The center 56 may be fabricated from steel, such as galvanized steel AISI 1055, for example. It is capable of supporting both a tensile load and a compressive load. The center 56 is surrounded by several wires, referred to as core strand wires 58.

The core strand wires 58 include a series of individual wires. The core strand wires 58 are wrapped around the center 56 in a helical pattern. The helical pattern permits the core 50 to bend and flex. There is a first row 62 of core strand wires 58 adjacent the center 56. A thin layer of epoxy, insulation or lubricant may be placed between the center 56 and the first row 62.

A second row 64 of wires similarly wrapped may also be found. The second row 64 is adjacent the first row 62. This second row 64 includes more core strand wires 58 than the first row 62 and is further away from the center 56. A thin layer of epoxy, insulation or lubricant may also be placed between the first row 62 and the second row 64.

Although, two rows are shown, several rows of wires may be used or only one row may be used, depending on the size requirements for the push-pull cable connection 10. In some embodiments, between eight and sixteen core strand wires 58 can be used for the first row 62. Between nine and fifteen core strand wires 58 may also be used. Other embodiments use between fourteen and twenty-two core strand wires 58 for the second row 64. Still other embodiments may use between fifteen and twenty-one core strand wires 58 for the second row 64. Still, other embodiments may use more or less wires according to the specific application. One skilled in the art and having this disclosure will be able to select an appropriate number of wires for a specific application.

The core strand wires 58 may be formed from any material. Examples include metals, ceramics or polymers. The core strand wires 58 may be formed of steel, preferably galvanized steel such as AISI 1065. Although shown having a circular cross section, the core strand wires 58 may have any shape cross section as desired and may have a variety of sizes between the various core strand wires 58. Moreover, the helical shape of the wrap of the core strand wires 58 may be of a right-hand or left-hand lay. The first row 62 and second row 64, or subsequent rows may also be laid in alternating helixes.

The core strand wires 58 in turn are encircled by a core jacket 66. The core jacket 66 has a generally tubular shape. Spaced circumferentially at its outer edge are a plurality of splines 68. Between the splines 68 are valleys or gaps 70. The splines 68 assist in positioning the core 50 and the core strand wires 58 within the push-pull cable connection 10. The core jacket 66 may be fabricated from any material. Nylons may be particularly suitable, specifically Nylon 11 or Nylon 66.

Encircling the core 50 is the conduit 44. Radiating outward from the core jacket 66 is the conduit liner 72. The conduit liner 72, tubular in shape, may be formed from a polymer. Outside the conduit liner 72 are conduit strand wires 74 comprising a plurality of wires. These conduit strand wires 74 are similar to the core strand wires 58 in function and strengthen the conduit liner 72. The conduit strand wires 74 may also be made of steel or other suitable material.

The conduit strand wires 74 are housed in a tubular conduitjacket 78. The conduit jacket 78 is extruded over the conduit strand wires 74 and provides additional strength and protection to the push-pull cable connection 10. Further, the conduit jacket 78 provides protection for the conduit strand wires 74 and provides additional compressive strength for the conduit 44.

FIG. 3 is a detailed view of a push-pull cable connection 10. Here it is evident that the rod 12 diameter and the core 50 diameter are substantially similar. In some embodiments, the two diameters are identical. The rod 12 has a first counter bore 80 and a second counter bore 82. The counter bores 80 and 82 may be formed using a stepped drill or any other suitable means of creating a hole.

The first counter bore has a length X and the second counter bore has a length Y. Further, the first counter bore 80 has a smaller diameter than the second counter bore 82. In particular, the diameter of the first counter bore 80 is approximately equivalent to the diameter of the second layer 64.

In forming the push-pull cable connection 10, the core jacket 66 is removed from the second layer 64 exposing a length of the second layer 64 equivalent to a length X. Then, an outside circumferential portion of the core jacket 66 is removed from the core 50 for a length equivalent to Y. The diameter of the core 50 with the remaining circumferential portion of the core jacket 66 for the length Y, is equivalent to the diameter of the second counter bore 82.

In some embodiments, the core 50 is inserted into the rod 12 such that the second layer 64 (with the core jacket 66 removed for a length X) enters the first counter bore 80 and forms a metal-to-metal contact with the metallic rod 12. This metal-to-metal contact forms a strong rigid connection. The remaining core 50 with a portion of the core jacket 66 removed for a length Y, is subsequently inserted and contacts the second counter bore 82, allowing the rod 12 to entrap the core 50 for a length of X plus Y. Finally, the remaining length Z of the core 50, where a portion of the core jacket 66 has not been removed, abuts the second end 16 of the rod 12.

Referring again to FIG. 2, The splines 68 and the gaps 70 of an embodiment of the present invention are larger, perhaps 10% or greater of the length from the spline's tip to the center of the core 50. In an embodiment of the present invention, the corejacket 66 is extruded to provide the core 50 to have the same diameter as that of the rod 12. The splines 68 are more pronounced and subsequently, the gaps 70 are larger. Air occupies the gaps 70 between the splines 68. The air travels with the core 50 as the core 50 is translated within the push-pull cable connection 10. The large size of the splines 68 facilitate movement of the air and reduces or prevents the air from being compressed within the swivel sleeve 18 as the jacket 66 moves within the push-pull cable connection 10.

Moreover, the movement of the air also reduces or prevents contaminant from being drawn into the push-pull cable connection 10. As the core 84 is translated axially within the conduit 96, in some cable assemblies, the movement of the core 84 may create areas of high pressure and low pressure due to the air present in the gaps between the rod diameter 12 and the core diameter 50 within the sleeve 18. The difference in diameter between the rod 12 and the core 50 may create such low pressure vacuums and permit contaminant to be drawn in. However, in some embodiments of the present invention, the gaps 70 are large, allowing the air to travel more easily from one end of the cable to the other end of the cable, reducing or eliminating the creation of low pressure areas. Thus, little or no contaminant may be drawn in.

Although the larger splines 68 reduce or eliminate the pumping action that results from small splines, they also reduce the amount of friction between the core 50 and the conduit 44, in that the splines 68 at their outer edge have a low surface area. This low surface area reduces the amount of contact between the core 50 and the conduit 44. The spline 68 height may be between 0.01 inches and 0.06 inches. In an embodiment of the invention, the spline height may be 0.03 inches.

In a preferred embodiment of the present invention, the diameter of the core 50 may be increased by increasing the size of the splines 68. However, any component of the core 50 may be used to increase the size of the core 50. For instance, the diameter of the center 56 may be increased. The number or size of the core strand wires 58 may also be increased by providing an additional row of core strand wires 58 or by increasing the size of the core strand wires 58.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A push pull cable connection, comprising:
a rod having a first diameter; and
a core disposed adjacent the rod wherein the core has a second diameter and wherein the first diameter and the second diameter are substantially similar.

2. The push pull cable connection of claim 1, wherein the rod and the core are coaxial.

3. The push pull cable connection of claim 1, wherein the rod is coupled to the core.

4. The push pull cable connection of claim 1, wherein the core comprises a plurality of splines.

5. The push pull cable connection of claim 1, wherein the core comprises
a center coaxial with the rod;
a plurality of wires wrapped around the center; and
a core jacket encasing the plurality of wires, wherein the core jacket has a plurality of splines circumferentially spaced on the core jacket and wherein the core jacket has a second diameter substantially similar to the first diameter.

6. The push pull cable connection of claim 5, wherein the center, the plurality of wires and the core jacket are coupled to the rod.

7. The push pull cable connection of claim 5, wherein the rod has a first counter bore and a second counter bore disposed within the rod;
the center is disposed adjacent the rod;
the plurality of wires are wrapped around the center; and
the core jacket encasing the plurality of wires, wherein the core jacket comprises a plurality of splines and wherein a core jacket diameter is substantially similar to a rod diameter.

8. The push pull cable apparatus of claim 7, wherein a height of the spline is 10 percent or greater of the length from a tip of the spline to a middle of the center.

9. The push pull cable apparatus of claim 7, wherein the first counter bore has a first diameter and the second counter bore has a second diameter.

10. The push pull cable apparatus of claim 9, wherein the first diameter is smaller than the second diameter and wherein the first diameter is substantially similar to a second layer diameter.

11. The push pull cable apparatus of claim 7, wherein the center is inserted into the first counter bore.

12. The push pull cable apparatus of claim 7, wherein a portion of the core jacket is inserted into the second counter bore.

13. A method of manufacturing a push pull cable connection, comprising:
providing a rod;
forming a first counter bore into the rod;
forming a second counter bore into the rod, wherein the second bore has a first diameter;
inserting a second layer into the first counter bore;
surrounding the second layer with a core jacket; and
removing a circumferential portion of the core jacket along a length of the core jacket wherein a remaining circumferential portion of the core jacket has a second diameter substantially similar to the first diameter.

14. The method of claim 13, further comprising the step of inserting the length of the core jacket into the second counter bore.

15. The method of claim 13, wherein a plurality of wires is disposed between the center and the core jacket.

16. The method of claim 15, wherein the plurality of wires wraps around the center.

17. The method of claim 13, wherein a first diameter of the rod is substantially similar to a second diameter of the core jacket.

18. The method of claim 13, wherein the rod and the center are coaxial.

19. A push pull cable connection system, comprising:
a first supporting means; and
a second supporting means disposed adjacent the first supporting means, wherein the first supporting means comprises a first diameter and the second supporting means comprises a second diameter, and wherein the first diameter and the second diameter are substantially similar.

20. The push pull cable system of claim 19, wherein the first supporting means and the second supporting means are coaxial.

21. The push pull cable system of claim 19, wherein the first supporting means is coupled to the second supporting means.

22. The push pull cable system of claim 19, wherein a portion of the second supporting means is inserted into the first supporting means.
